(19) United States
(12) Patent Application Publication
(10) Pub. No.: US 2019/0311319 A1
(43) Pub. Date: Oct. 10, 2019

(54) COMPREHENSIVE NO-TOUCH INVENTORY MANAGEMENT SYSTEM

(71) Applicants: Thomas James Cote, Woodinville, WA (US); Kristopher Lane Daniels, Kirkland, WA (US); Marcus Alexandr Horstmann, Woodinville, WA (US)

(72) Inventors: Thomas James Cote, Woodinville, WA (US); Kristopher Lane Daniels, Kirkland, WA (US); Marcus Alexandr Horstmann, Woodinville, WA (US)

(21) Appl. No.: 16/376,218

(22) Filed: Apr. 5, 2019

Related U.S. Application Data
(60) Provisional application No. 62/654,522, filed on Apr. 8, 2018.

(51) Int. Cl. G06Q 10/08

(52) U.S. Cl. CPC G06Q 10/087

(57) ABSTRACT

A system directed to inventory in an enclosure employs sensors and data processing to provide real time inventory management without requiring additonal user action. Adaptable to storage units such as refrigerators, cabinets and pantries, and particularly useful for tracking perishable items, object recognition rechnology generates time-stamped data identifying objects as they are placed in and removed from the enclosure, thereby enabling an associated database to maintain inventory of objects in the enclosure in real time. Embodiments further comprise sensors providing weight data for an object as it is placed in the enclosure, enabling the inventory database to track item weights. The system database enables software means to provide users actionable information such as expiration alerts, recipes, shopping lists, dietary recommendations and other information concerning food items in the enclosure.

### CROSS-REFERENCE TO RELATED APPLICATION

This application claims the benefit of U.S. provisional patent application No. 62/654,522, filed Apr. 8, 2018.

### BACKGROUND OF THE INVENTION

### Field of the Invention

This invention relates to inventory management systems. More specifically, this invention relates to systems adapted to automatically manage an inventory of items, such as foodstuffs, which may have limited usable lifespans.

### Description of the Related Art

It has been estimated that the average household in a developed nation wastes 40% of their yearly food purchases. Such waste is largely the result of inadequate management of inventories of perishable food items.

Earliest efforts to manage perishable inventories entailed tedious manual tabulation of items as they were entered into and removed from storage. Some more recent efforts to automate inventory management have been limited to items packaged with bar codes such as the Universal Product Code, enabling an inventory management system to identify and track such items by scanning them as they move in and out of inventory. Other recent efforts have required users to label each item in inventory with a radio frequency identification marker to enable automated item identification and tracking. More recent efforts to apply artificial intelligence technology to the task have been limited to particular kinds of items such as fresh vegetable produce.

What is needed is a system for tracking perishable items automatically as they are placed in and removed from storage in an enclosure such as a refrigerator, cabinet or pantry. What is needed further is such a system that tracks such items in the form in which they are acquired by the user, without requiring additional labeling or other intervention by the user. Further, what is needed is such a system with universal capability, adaptively tracking perishable items of all kinds. Yet further, what is needed is an automated system that provides users with actionable information and functionality to optimize the management of perishable foods or other items with limited lifespans.

### SUMMARY OF THE INVENTION

This system uses at least one sensor such as a camera or lidar scanner disposed within a storage unit such as a refrigerator, cabinet or pantry, to acquire data on the contents of the storage unit. The system applies object identification technology to processes the data thus acquired, automatically identifying items as they are placed in and removed from the storage unit. Time-stamped records of the automatically identified items are recorded in a system database. Embodiments further include weight sensors enabling item records further to include item weight data. A user interface enables actionable and supervisory information exchange between the user and the system. A provider interface enables item ordering transactions with item providers.

### BRIEF DESCRIPTION OF THE DRAWINGS

Objects of the present invention as well as advantages, features and characteristics, in addition to methods of operation, function of related elements of structure, and the combination of parts and economies of manufacture, will become apparent upon consideration of the following description and claims with reference to the accompanying drawings, all of which form a part of this specification, wherein like reference numerals designate corresponding parts in the various figures, and wherein:

FIG. 1. illustrates the standard configuration of a refrigerator in the prior art without the system added;

FIG. 2. illustrates the system configured to work in a refrigerator;

FIG. 3. illustrates a system added to a smaller enclosed space, such as cabinet, pantry, or mini-fridge;

FIG. 4. is a flow diagram of a routine that captures each new item added to the enclosed space by the system and added to a database for further use;

FIG. 5. is a diagram of a routine that enables the data collected to be used for smart recommendations;

FIG. 6 is a diagram of a routine for alerting a consumer when an item is about to expire;

FIG. 7 is a diagram of a routine for generating a purchase for new goods;

FIG. 8 is a diagram of a routine for creating a meal plan and optimizing the purchase of goods; and

FIG. 9 is a block diagram illustrating one embodiment of the disclosure.

### DETAILED DESCRIPTION OF THE INVENTION

In a typical embodiment of the invention, one or more image sensors are disposed within the target storage unit. Image sensors may be cameras, lidar scanners, sonar, radar or other devices suitable for obtaining a representation of the contents of the storage unit in the form of image data. Sensors are so situated within the storage unit that the image obtained by the sensors encompasses objects stored within the storage unit. Image sensors may be statically mounted to receive a constant perspective of the interior of the storage unit. Alternatively, image sensors may employ reciprocating motors to pivot and scan wide areas of the storage unit.

The image sensors are in communication with image processing equipment which receives storage unit content image data from the sensors. It will be understood by those of skill in the art that the image processing equipment associated with this system may be local to the storage unit, or that image processing equipment may be located distantly from the storage unit, receiving image sensor data via network or other transmission means. In yet other embodiments, the system image processing functionality may be widely distributed over equipment and networks employed by the system for this purpose.

The image processing functionality of this system operates on image data received from the sensors to recognize objects in the storage unit. The system latency for object recognition is on the order of seconds rather than minutes, sufficiently short as to be characterized as real-time. Embodiments may practice object recognition by image processing employing software systems that have been trained in the deep learning technologies of artificial intelligence, relying, for example, on convolutional network architecture, in some cases Space Displacement Neural Networks in particular, to ensure some degree of shift, scale and distortion invariance in the process of image recognition training. In some such systems, a regularized linear model of a three dimensional object is created in software and the model is associated with the identity of the object. Thereby an initial dataset is created that correlates idealized representations of image data with object identity. Dataset augmentation is carried out by presenting an object recognition software system in training with various transformations of object representations that do not change the class of object presented. Such transformations include random rotations, translations and in some cases random perturbation of colors and nonlinear distortions of the object representations. After many iterations of dataset augmentation, the image recognition software system has been trained to identify objects represented in the image data, reliably and in real or near-real time.

While it will be recognized by those of skill in the art that many different programming and training approaches employing a range of supporting architectures can be used to implement object recognition in a software system, any image data processing means for providing reliable near-real time object identification from the system's image data, without requiring user input or labeling of items, is adaptable to be incorporated in this system. In accordance with the teachings of this invention, then, system image processing receives image data as input and, through object recognition technology, provides item identification data as output.

A system inventory database receives item identification data from the image processing equipment, creating inventory data records as items are placed in and removed from the storage unit. Thereby, the system maintains and updates its database, providing real-time inventory of items in the storage unit. By time-stamping inventory data records, the system can track item aging. Embodiments further include weight sensors, enabling item weight data to be included in the inventory data record for each item.

A user interface to the system inventory database enables a user to determine the contents of the storage unit at any time. The user interface can aggregate data on like or identical items in storage to report an inventory of unique items to the user. When the system includes time-stamping of inventory data records, the user interface can provide the user with information regarding the aging of perishable items in the storage unit. Additional software functionality enables the system to provide the user with alerts regarding deadlines for perishable items and shortfalls of item quantities. Other software may provide the user with item usage suggestions such as recipes and nutritional recommendations. Yet other software in conjunction with a provider interface may enable manual or automatic (no-click) ordering of new items from item providers based upon inventory data and/or user specified parameters such as desired replenishment frequency.

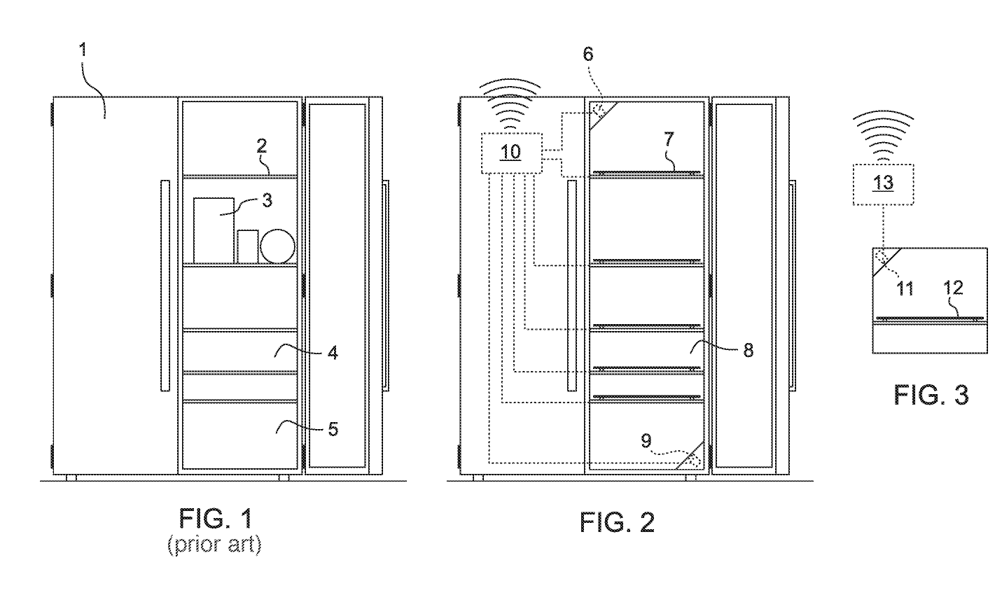

Referring now to the figures, wherein like numerals indicate like or corresponding parts throughout the several views, an exemplary prior art refrigerator is generally shown at FIG. 1, generally indicated at 1. For purposes of illustration and not by way of limitation, the following description relates to the interior refrigerator-mounted application of the present invention such as that depicted in FIG. 2. However, the system is equally applicable to inventory in a refrigerator, cabinet, closet, or pantry, among other things.

Turning to FIG. 1, a standard prior art refrigerator 1 is depicted without the system of the present invention, according to one embodiment. The refrigerator contains shelves 2, some currently purchased goods 3, small bins for storage 4, and large bins for storage 5. These various sections can be omitted and rearranged or adapted in various ways. In general, the storage location only need to be able to hold and store physical goods. As shown in subsequent drawings, the present invention adds a system able to record goods without user input and use that data for later optimization.

FIG. 2 illustrates the system of the present invention configured in a standard refrigerator, according to one embodiment. As illustrated, the system contains two sensor modules 6, 9 placed to allow optimal image capture. Sensor modules 6, 9 may be cameras capturing images in the visible or infra-red spectrum. Alternatively, sensors 6, 9 may be lidar scanners, sonar, radar or other devices suitable for obtaining a representation of the contents of the refrigerator in the form of image data. Pads 7, 8 provide item weight data from the refrigerator's shelves or bins. Sensors 6, 9 and pads 7, 8 communicate electronically to microcontroller 10 which provides transfer of image and weight data to the invention's associated data processing equipment (not illustrated).

FIG. 3 illustrates another embodiment of the system in a standard cabinet. Here the system contains one camera 11 as an image sensor, one scale 12 measuring weight, and one microcontroller 13. When the user adds any new items to a storage unit containing the system, data regarding that item is automatically captured by sensor 11 and scale 12 and transferred by microcontroller 13 to data processing equipment as described in regards FIG. 1 above.

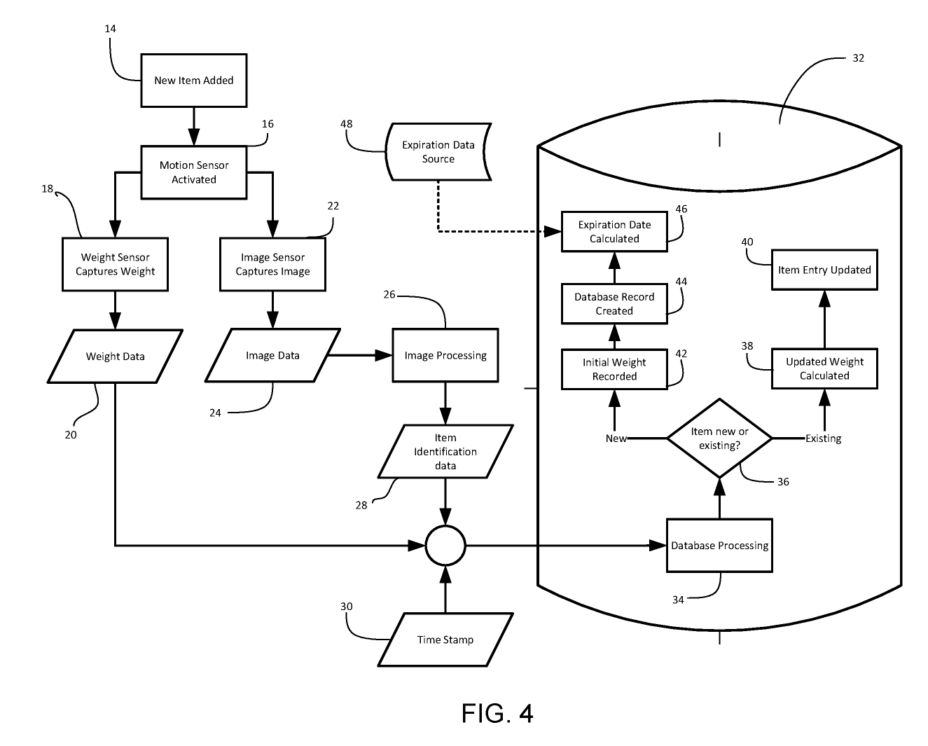

FIG. 4 illustrates data flow in an embodiment of the invention. The user adds a new item 14 to the storage unit. This action is detected by motion sensor which becomes activated 16. Alternatively, not depicted, the action of adding or removing items from the storage unit can be detected by a sensor that is activated upon the opening of the door of the storage unit. In any case, the activation causes a weight sensor to capture weight 18 of the item and an image sensor to capture an image 22 of the storage unit's interior including the item. The capture of item weight 18 results in the production of item weight data 20. The image capture 22 produces image data 24 which is processed by image processing 26 with object recognition technology as discussed above to produce item identification data 28, identifying the item that has been placed in the storage unit.

Weight data 20, item identification data 28 and time stamp data 30 are communicated to system inventory database 32 for database processing 34. Database processing 34 determines 36 whether the item is new to the inventory or whether an item of the same type is already existing in inventory. If the item is new, its initial weight is recorded 42, a database record is created for the item and an expiration date is calculated 46, optionally using expiration data from an external source 48, the expiration date then associated with the database record for the item.

If database processing 34 determines 36 that the item is of the same sort as other items existing in inventory, then the total weight of those items is calculated 38 and the database record for that item type in inventory is updated 40.

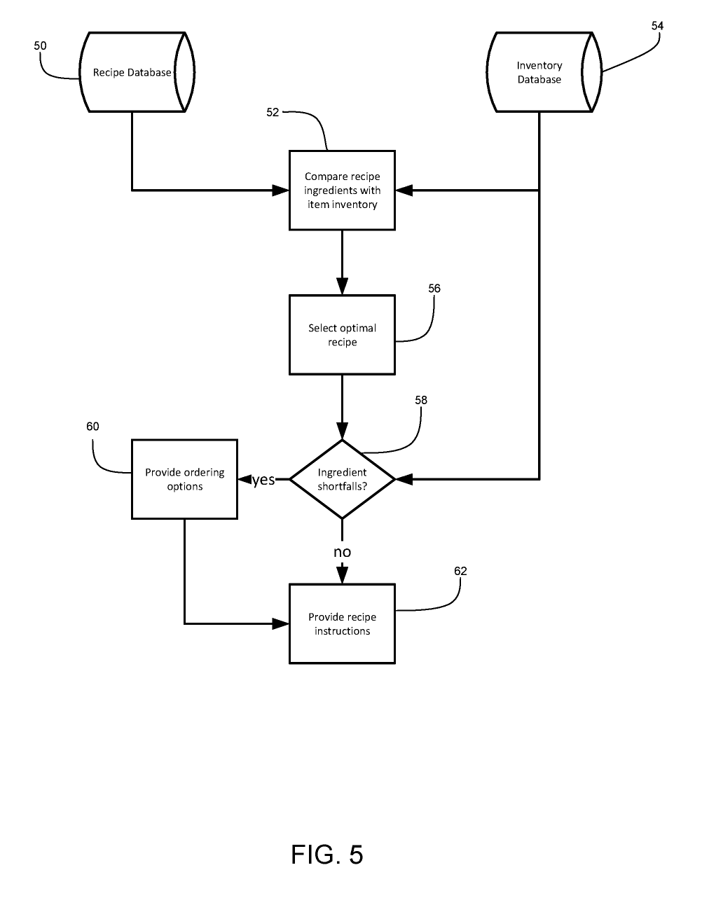

An exemplary user action made possible with this system is illustrated in FIG. 5, in which a database 50 of recipes is automatically compared 52 by ingredients with the inventory database 54 of items stored in the storage unit. As a result of such comparison, a recipe is selected 56 that optimizes use of items recorded in the inventory database 54. If the system determines 58 that the inventory database indicates a shortage of certain items required for the selected recipe, ordering options for such items 60 are provided to the user, who also receives recipe instructions 62.

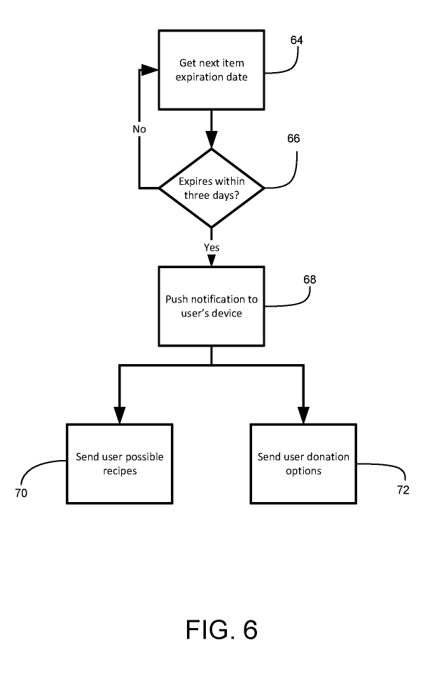

Having calculated and stored the expiration date for an item in the inventory database (FIG. 4, element 46), the system can review expiration dates for items in inventory and provide information for the user to take appropriate action, as shown for an embodiment in FIG. 6. Getting the expiration date for an item 64, the system determine whether the expiration date is within some set time limit of the current time, three days in the embodiment illustrated 66. If the expiration date is farther out than the set time limit, the system examines the expiration date of another item 64. If the expiration date is within the set time limit for the item, the system pushes notifications to the user's device 68. The user's device may be a laptop, a tablet, a smart phone, a desktop computer or any other device configured and connected to deliver notifications to the user. In the present exemplary embodiment, the system sends the user actionable information on possible recipes 70 to consume the expiring items and on donation options 72 should the user not care to consume the expiring items.

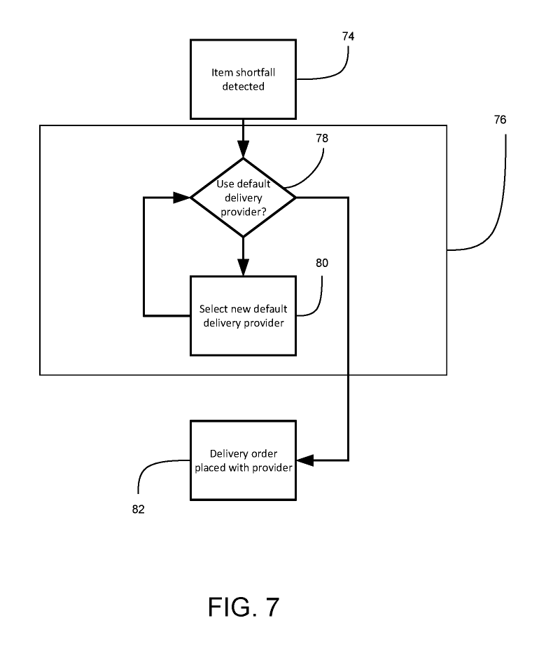

The system may determine that restocking of items is required, for example when the inventory database indicates that quantities of an item have fallen below a certain pre-set threshold, or, as shown at 58 in FIG. 5, when a there are insufficient quantities of an item required as an ingredient for a particular recipe. Turning now to FIG. 7, illustrated is an exemplary user interface providing the user with ordering options for the item in question. When an item shortfall is detected 74, item ordering interface 76 is triggered to provide ordering options. The user is presented with the option 78 of using a default delivery provider 80 for such item or selecting another delivery provider 82 who then is used as the default delivery provider 80. It will be appreciated by those in the art that different delivery providers may be required for different items. Embodiments of the present invention may keep a database associating specific delivery providers with specific items. In any case, when a delivery provider has been selected, a system provider interface enables placement of the item order automatically with the selected delivery provider 84.

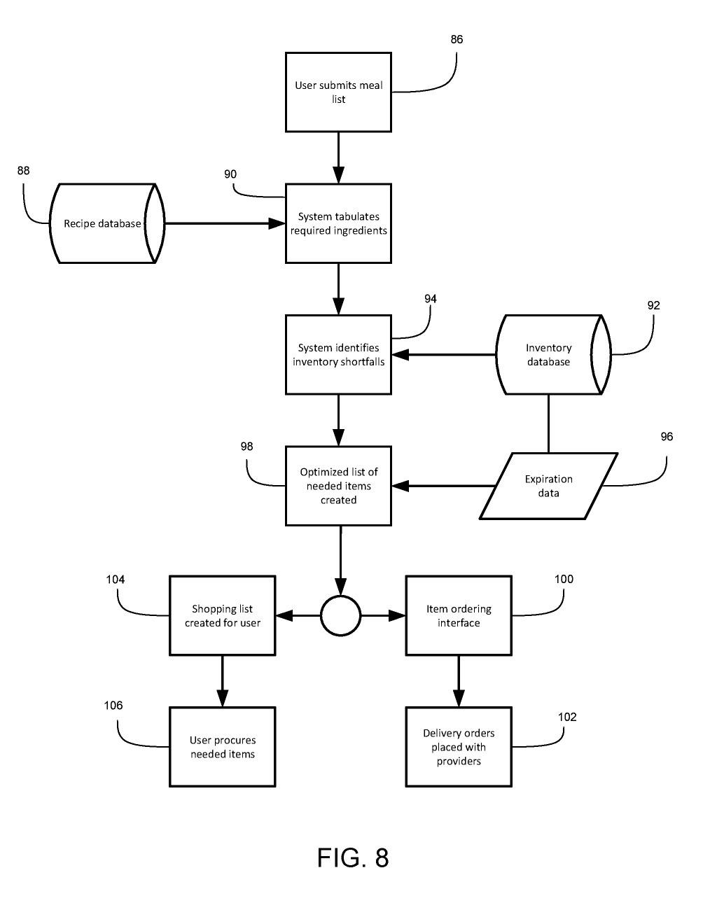

The system can further assist the user in optimizing a user meal plan. Turning to FIG. 8, the user submits a plan listing desired meals 86 to the system. Accessing a recipe database 88, the system determines and tabulates ingredients 90 required to prepare meals in the user's meal plan. Accessing the inventory database 92, the system identifies shortfalls in inventory 94. Accessing expiration data 96 associated with item records in database 92, the system creates a list of needed items 98 optimized to maximize use of perishable items already in inventory. As described previously in reference to FIG. 7, the system can present an item ordering interface 100 for ordering items needed to prepare meals in the user's meal plan, utilizing a provider interface automatically to place delivery orders with providers 102. Alternatively, the system can create a shopping list 104 for the user to procure items 106 needed for the meal plan. As items are acquired for the meal plan and placed in the storage unit associated with the system, the system inventory of items is automatically updated as discussed previously in reference to FIG. 4.

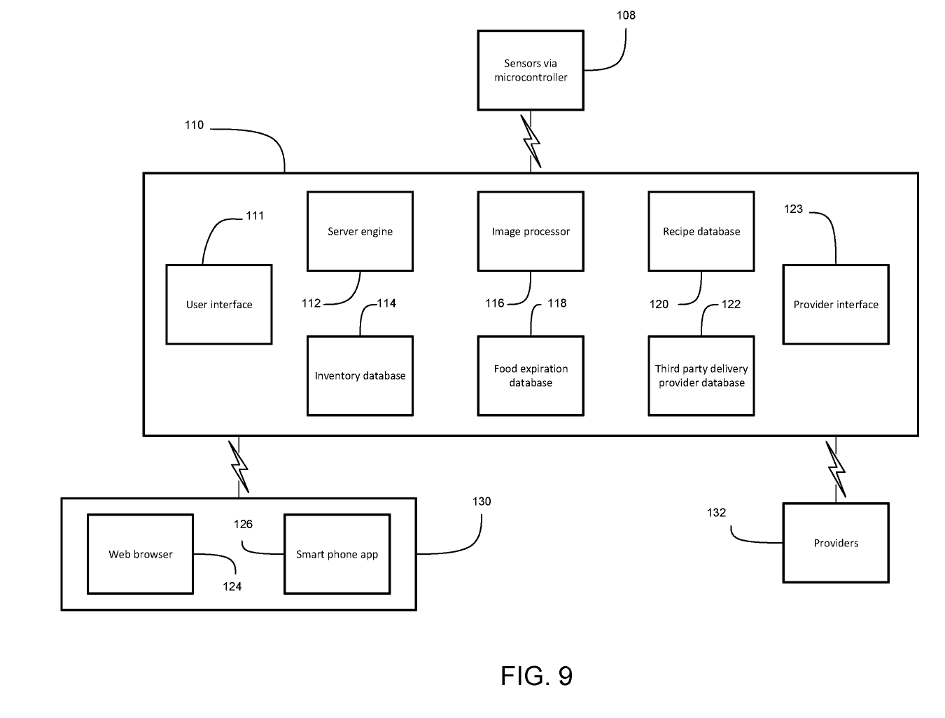

FIG. 9 is a block diagram illustrating an embodiment of the present system. Sensor data is communicated by microcontroller 108 networked to the system's data processing equipment. The system data processing equipment is shown generally as a server/client system comprising server component 110 in networked communication with client component 130. Server 110 comprises a server engine 112, an inventory database 114, and the functionalities of an image processor 116 for object identification, a food expiration database 118, a recipe database 120 and a third party delivery provider database 122. Those of skill in the art will recognize that various server functionalities such as image processor 116, food expiration database 118, recipe database 120 and third party provider database 122 may rely on external sources of data for their operation yet still be in keeping with the teachings of the present invention.

In the depicted embodiment, a user interface 111 is provided to enable server 110 to interact with client 130 via the Internet over the World Wide Web to provide the user with supervisory and actionable inventory management capabilities via common network client functionalities such as web browser 124 and smart phone app 126. It will be appreciated by those of skill in the art, however, that the system may use various communication channels, such as local area networks (LANs), wide area networks or peer-to-peer systems, alone or in combination, for communication between the various system components in keeping with the spirit of the present invention.

The depicted embodiment also comprises a provider interface 123, employing a communication channel to interact with external providers of items 132. Provider interface 123 enables ordering of new inventory items from providers 132, either as directed by the user via user interface 111 or automatically under control of server engine 112 such as when shortfalls are indicated in inventory database 114.

Persons of skill in the art will recognize that user interface 111 need not be implemented in whole within server 110 but rather may at least be partially implemented in client 130. Persons of skill in the art will further recognize that server 110 may communicate with a provider client system (not illustrated) at a provider 132 whereby part or all of provider interface 123 is implemented in such provider client system.

Although the present system has been described in terms of various embodiments, it is not intended that the system be limited to these embodiments. For example, the system can be utilized for inventory management in other environments where no-touch inventory recording would be preferred. The data created by the system may also be used in different ways. For example, new items can be announced via voice command spoken to the user.

While the invention has been described with a certain degree of particularity, it should be recognized that elements thereof may be altered by persons skilled in the art without departing from the spirit and scope of the invention. Accordingly, the present invention is not intended to be limited to the specific forms set forth herein, but on the contrary, it is intended to cover such alternatives, modifications and equivalents as can be reasonably included within the scope of the invention. The invention is limited only by the following claims and their equivalents.

1-12 (canceled)

13. A system for managing inventory in a storage unit, comprising:
at least one image sensor disposed within the storage unit, the image sensor configured to transmit image data of the contents of the storage unit;
an image processing system configured to receive the image data from the at least one image sensor, the image processing system further comprising means for processing the image data to derive item identification data identifying items by item type contained in the storage unit in real-time, the image processing system further configured to transmit the item identification data;
a data processing system configured to receive item identification data from the image processing system, the data processing system further configured to provide an inventory database with item identification data, the inventory database containing a listing of each item by item type in the storage unit; and
a user interface to the system for managing inventory.

14. A system for managing inventory according to claim 13,
further comprising a weight detection sensor configured to provide item weight data to the data processing system and wherein
the data processing system is further configured to receive item weight data from the weight detection sensor and further configured to provide item weight data with item identification data, whereby the inventory database further contains item weight data in the listing of each item by item type in the storage unit.

15. A system for managing inventory according to claim 13, wherein
the data processing system is further configured to provide time-stamp data with item identification data, whereby the inventory database further contains the time of item acquisition in the listing of each item in the storage unit, thereby enabling the data processing system to compute the age of each item in the storage unit.

16. A system for managing inventory according to claim 15 further having a food expiration database comprising entries of expected storage lives for individual food item types and wherein
the data processing system is further configured to compare the age of each item by item type in the storage unit to the entry in the food expiration database of expected storage life corresponding to the food item type, and
the data processing system and the user interface are further configured so that the user interface provides an alert to the user when the data processing system determines that the age of an item is within a pre-set value of the expected storage life of the item type.

17. A system for managing inventory according to claim 13, wherein
the user interface is configured to provide a user with a display listing items in inventory in the storage unit in real time.

18. A system for managing inventory according to claim 17 further having a provider interface and wherein
the user interface is further configured to accept user input identifying items to be procured, and
the provider interface is configured to transmit order instructions to providers of items that the user has identified to be procured.

19. A system for managing inventory according to claim 13, further having a recipe database and wherein
the data processing system is further configured to compare ingredients in the recipe database with items by item type in the inventory database and to derive recipe suggestions optimizing use of inventory items, and
the user interface is configured to provide the user with a display listing recipe suggestions derived by the data processing system.

20. A system for managing inventory according to claim 19 having a provider interface and wherein
the user interface is further configured to enable a user to select a recipe suggestion,
the data processing system is further configured to determine shortfalls between ingredients in a recipe selected by the user and items in the inventory database,
the user interface is further configured to display item shortfalls for a user selected recipe and to prompt the user to confirm orders to procure needed items, and
the provider interface is further configured to transmit orders confirmed by the user to providers of the needed items.

21. A system for managing inventory according to claim 20 further having a provider database and wherein
the user interface is further configured, in response to user item order confirmation, to prompt the user for input of selection from the provider database of a provider for the item, and
the provider interface is further configured to transmit item order instructions to the user selected provider.

22. A system for managing inventory according to claim 13 wherein the storage unit is one of a refrigerator, a cupboard and a pantry.

23. A method for managing inventory in a storage unit, comprising the steps of
obtaining image data of the contents of the storage unit,
processing the image data to derive item identification data,
updating an item inventory database with item identification data, and
providing at least one of a user interface and a provider interface to the item inventory database.
